(19) United States
(12) Patent Application Publication
(10) Pub. No.: US 2019/0155111 A1
(43) Pub. Date: May 23, 2019

(54) OPTICAL DEVICE, AND WINDOW PROVIDED WITH LIGHT DISTRIBUTION FUNCTION

(71) Applicant: PANASONIC INTELLECTUAL PROPETY MANAGEMENT CO., LTD., Osaka (JP)

(72) Inventors: Yuji TANAKA, Osaka (JP); Kazuki KITAMURA, Osaka (JP)

(73) Assignee: PANASONIC INTELLECTUAL PROPERTY MANAGEMENT CO., LTD., Osaka (JP)

(21) Appl. No.: 15/774,467

(22) PCT Filed: Nov. 11, 2016
(86) PCT No.: PCT/JP2016/004863

§ 371 Date: May 8, 2018

(30) Foreign Application Priority Data
Jan. 7, 2016 (JP) 2016-002045

(51) Int. Cl. G02F 1/1343; E06B 9/24

(52) U.S. Cl. CPC G02F 1/134336; E06B 2009/2464; E06B 9/24

(57) ABSTRACT

An optical device includes: a first substrate which is light-transmissive; a first electrode disposed above the first substrate; an uneven layer disposed above the first electrode; a refractive-index adjustment layer disposed above the uneven layer; and a second electrode disposed above the refractive-index adjustment layer. At least one of the first electrode and the second electrode includes a plurality of pattern electrodes aligned in a first direction. The plurality of pattern electrodes include pattern electrodes which are adjacent to each other and separation regions are each formed between adjacent ones of the plurality of pattern electrodes. At least one of areas of the plurality of pattern electrodes and areas of the plurality of separation regions vary successively in the first direction.

### TECHNICAL FIELD

The present invention relates to an optical device and a window that has the optical device and a light distribution function.

### BACKGROUND ART

An optical device has been proposed which can change a traveling direction of outside light, such as sunlight entering from outside a room, and introduce the outside light into the room.

For example, Patent Literature 1 (PTL 1) discloses a lighting sheet that is affixed to a window to change a traveling direction of incident sunlight and introduce the incident sunlight into a room. The lighting sheet disclosed in PTL 1 has a reflecting surface that is formed by filling a recessed groove formed in a transparent sheet material with a filler. An optical path of sunlight is deflected by reflection of this reflecting surface. As a result of this, the sunlight illuminates, for example, a ceiling surface of the room.

### CITATION LIST

### Patent Literature

PTL 1: Japanese Unexamined Patent Application Publication No. 2012-255951

### SUMMARY OF THE INVENTION

### Technical Problem

An optical device has been studied which can change the traveling direction of incident light (or more specifically, can perform light distribution) as described above. By affixing such an optical device to a window, outside light, such as sunlight, can be brought in toward the back of the room. Thus, the outside light can be casted on a large area of the room, and thereby enhance indoor illuminance. Hence, an indoor lighting fixture can be turned off, and an optical output of the indoor lighting fixture can be reduced. This results in electrical power saving.

However, when the outside light is distributed and brought into the room using the optical device described above, a difference in the amount of light is large at a boundary portion between inside and outside of a light region of the distributed light. More specifically, a difference in the amount of light is large between a space region through which the distributed light passes and a space region through which the distributed light does not pass. For this reason, when a person crosses the boundary portion of the distributed light (i.e., the boundary portion between a region to which the light is distributed and a region to which no light is distributed) to the light region, the person may be suddenly dazzled by bright light due to this large difference in the amount of light and thus feel discomfort.

The present invention is conceived in view of the stated problem, and has an object to provide an optical device which can reduce a feeling of discomfort caused at a boundary portion of distributed light.

### Solution to Problem

To achieve the aforementioned object, an optical device according to an aspect of the present invention includes: a substrate which is light-transmissive;

a first electrode which is disposed above the substrate; an uneven layer which is disposed above the first electrode; a refractive-index adjustment layer which is disposed above the uneven layer; and a second electrode which is disposed above the refractive-index adjustment layer, wherein at least one of the first electrode and the second electrode includes a plurality of pattern electrodes which are aligned in a first direction, the plurality of pattern electrodes include pattern electrodes which are adjacent to each other and separation regions are each formed between adjacent ones of the plurality of pattern electrodes, and at least one of areas of the plurality of pattern electrodes and areas of the plurality of separation regions vary successively in the first direction.

Moreover, a window provided with a light distribution function according to an aspect of the present invention includes: the optical device described above; and a window to which the optical device is affixed.

### Advantageous Effect of Invention

According to the present invention, even when a person crosses a boundary portion of distributed light to a light region, a sudden feeling of being dazzled can be suppressed. Thus, a feeling of discomfort caused at the boundary portion of the distributed light can be reduced.

### BRIEF DESCRIPTION OF DRAWINGS

FIG. 1 is a perspective view of an optical device viewed from the front side, according to Embodiment 1.

FIG. 2 is a cross-sectional view of the optical device along II-II line shown in FIG. 1, according to Embodiment 1.

FIG. 3 is an enlarged cross-sectional view of the optical device (an enlarged cross-sectional view of region III enclosed by a dashed line shown in FIG. 2) according to Embodiment 1.

FIG. 4 is an enlarged cross-sectional view showing a vicinity of region IV enclosed by a dashed line shown in FIG. 1.

FIG. 5 is a diagram showing an example of using the optical device according to Embodiment 1.

FIG. 6 is an enlarged cross-sectional view of region VI enclosed by a dashed line shown in FIG. 5.

FIG. 7 is a diagram showing a shape of a second electrode included in an optical device according to Variation 1 of Embodiment 1.

FIG. 8 is an enlarged cross-sectional view of an optical device according to Variation 2 of Embodiment 1.

FIG. 9 is an enlarged cross-sectional view of an optical device according to Variation 3 of Embodiment 1.

FIG. 10 is a diagram showing a shape of a second electrode included in an optical device according to Variation 4 of Embodiment 1.

FIG. 11 is a diagram showing a shape of a second electrode included in an optical device as another example according to Variation 4 of Embodiment 1.

FIG. 12 is a plan view showing an optical device viewed from the front side, according to Embodiment 2.

FIG. 13 is a cross-sectional view of the optical device along XIII-XIII line shown in FIG. 12, according to Embodiment 2.

### DESCRIPTION OF EXEMPLARY EMBODIMENTS

Hereinafter, embodiments according to the present invention are described. It should be noted that each of the embodiments below describes only a preferred specific example according to the present invention. Therefore, the numerical values, shapes, materials, structural elements, the arrangement and connection of the structural elements, and so forth described in the following embodiments are merely examples, and are not intended to limit the present invention. Thus, among the structural elements in the following embodiments, structural elements that are not recited in any one of the independent claims indicating top concepts according to the present disclosure are described as arbitrary structural elements.

Note that each of the accompanying drawings is only a schematic diagram and is not necessarily precise illustration. Thus, the reduction scales and the like in the drawings do not always agree with each other. Note also that, in all the drawings, the same reference numerals are given to the substantially same structural elements and redundant description thereof shall be omitted or simplified.

Moreover, X, Y, and Z axes mentioned in the present specification and accompanying drawings refer to three axes in three-dimensional Cartesian coordinate system. In the following embodiments, a Z axis direction refers to a vertical direction and a direction perpendicular to the Z axis (a direction parallel to an XY plane) refers to a horizontal direction. The X and Y axes are orthogonal to each other, and each of the X and Y axes is orthogonal to the Z axis. Here, a positive direction of the Z axis direction is a vertically downward direction. Moreover, a term “thickness direction” used in the present specification refers to a thickness direction of an optical device, and is a direction perpendicular to a main surface of a first substrate and to a main surface of a second substrate. Furthermore, a term “plan view” refers to a view seen from a direction perpendicular to the main surface of the first substrate and to the main surface of the second substrate.

### Embodiment 1

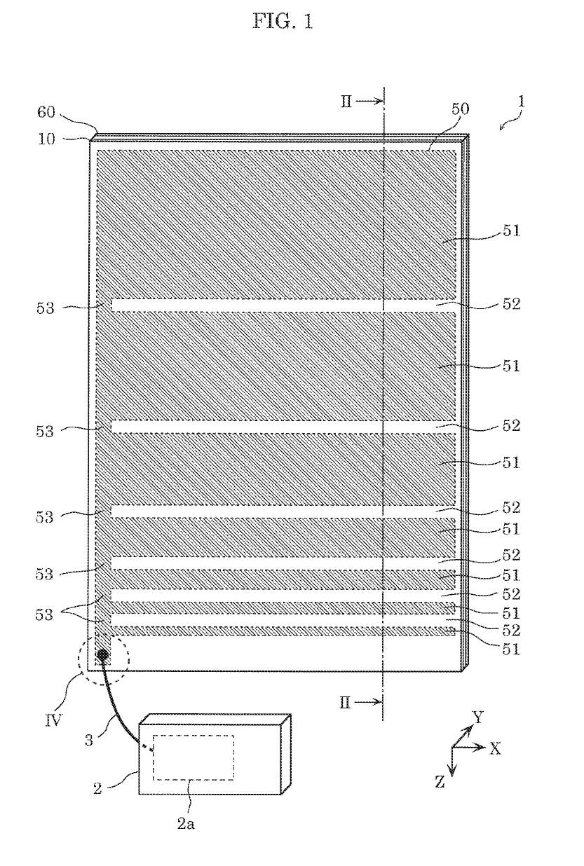

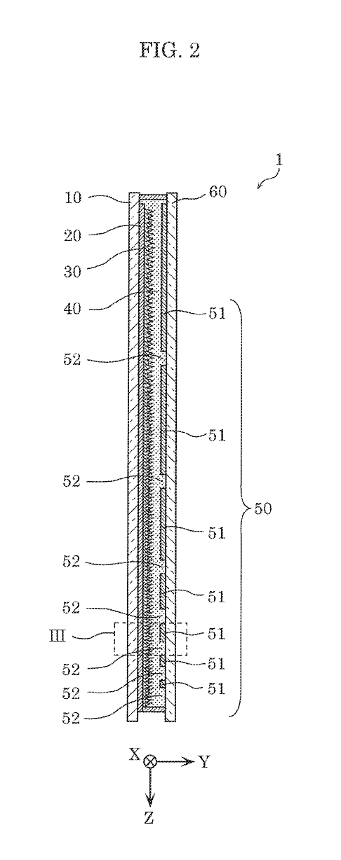

An entire configuration of optical device 1 according to Embodiment 1 is described, with reference to FIG. 1 and FIG. 2. FIG. 1 is a perspective view of optical device 1 viewed from the front side, according to Embodiment 1. FIG. 2 is a cross-sectional view of optical device 1 along II-II line shown in FIG. 1. It should be noted that, to easily find second electrode 50, an area in which second electrode 50 is disposed is hatched for the sake of convenience in FIG. 1.

Optical device 1 is a light control device which controls light entering optical device 1. To be more specific, optical device 1 is a light distribution element which can change a traveling direction of light entering optical device 1 (or more specifically, perform light distribution) and then emit the light.

As shown in FIG. 2, optical device 1 includes first substrate 10, first electrode 20, uneven layer 30, refractive-index adjustment layer 40, second electrode 50, and second substrate 60. Optical device 1 has a configuration in which first electrode 20, uneven layer 30, refractive-index adjustment layer 40, and second electrode 50 are arranged in this order in a thickness direction between a pair of first substrate 10 and second substrate 60.

Moreover, optical device 1 is electrically connected to power supply 2, as shown in FIG. 1. Power supply 2 (power supply box) includes feed circuit 2a for feeding optical device 1. An optical action to which light passing through optical device 1 is subjected changes depending on electric power supplied by power supply 2.

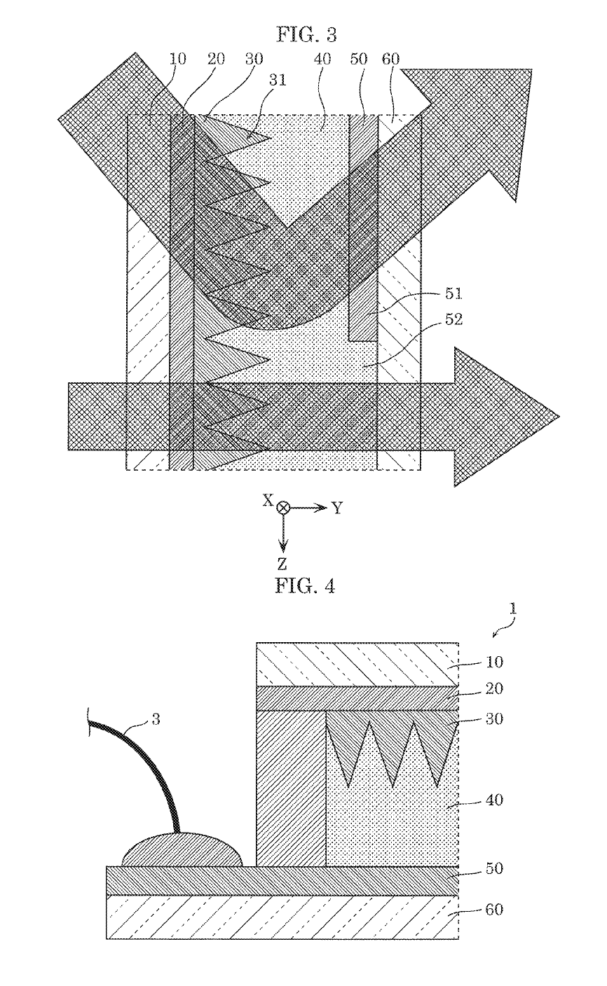

The following describes structural members of optical device 1 in more detail, with reference to FIG. 3 in addition to FIG. 1 and FIG. 2. FIG. 3 is an enlarged cross-sectional view of optical device 1 according to Embodiment 1, or more specifically, an enlarged cross-sectional view of region III enclosed by a dashed line shown in FIG. 2.

### [First Substrate and Second Substrate]

As shown in FIG. 2 and FIG. 3, first substrate 10 and second substrate 60 are disposed to sandwich a laminated structure that includes first electrode 20, uneven layer 30, refractive-index adjustment layer 40, and second electrode 50. First substrate 10 and second substrate 60 support and protect this laminated structure.

Each of first substrate 10 and second substrate 60 is a light-transmissive substrate having light transmissibility. As shown in FIG. 1, each of first substrate 10 and second substrate 60 is in a shape of, for example, a quadrangle such as a square or a rectangle in a plan view. However, the shape of these substrates is not limited to this, and may be a circle or a polygon other than a quadrangle. Thus, any shape can be adopted.

As shown in FIG. 2 and FIG. 3, second substrate 60 is an opposite substrate that opposes first substrate 10, and is disposed to be opposite to first substrate 10. First substrate 10 and second substrate 20 are bonded together by a sealing resin, such as an adhesive, that is formed in a shape of a picture frame around an outer perimeter for each of first substrate 10 and second substrate 60.

For example, glass substrates or resin substrates may be used as first substrate 10 and second substrate 60. Examples of a material of a glass substrate include soda glass, alkali-free glass, and high refractive index glass. Examples of a material of a resin substrate include polyethylene terephthalate (PET), polyethylene naphthalate (PEN), polycarbonate (PC), acrylic (PMMA), and epoxy. A glass substrate has the advantage of a high optical transmittance and a low moisture permeability. On the other hand, a resin substrate has the advantage of being shatter-resistant when broken. First substrate 10 and second substrate 60 may be formed from the same material or from mutually different materials. However, it is preferable for first substrate and second substrate 60 to be formed from the same material. A substrate used for each of first substrate 10 and second substrate 60 is not limited to a rigid substrate, and may be a flexible substrate having flexibility. In the present embodiment, first substrate 10 and second substrate 60 are formed using the same material. More specifically, first substrate 10 and second substrate 60 are transparent resin substrates that are formed from a PET resin and have the same size and the same shape in a plan view.

### [First Electrode and Second Electrode]

As shown in FIG. 2 and FIG. 3, first electrode 20 and second electrode 50 are formed to be an electrical pair that can apply an electric field to refractive-index adjustment layer 40. It should be noted that first electrode 20 and second electrode 50 are formed to be the pair not only electrically, but positionally as well. Thus, first electrode 20 and second electrode 50 are disposed to be opposite to each other. To be more specific, first electrode 20 and second electrode 50 are disposed in a manner to sandwich refractive-index adjustment layer 40.

First electrode 20 and second electrode 50 are light-transmissive and allow the incident light to pass through first electrode 20 and second electrode 50. First electrode 20 and second electrode 50 are, for example, transparent conductive layers. Examples of a material of the transparent conductive layer include the following: a transparent metallic oxide, such as indium tin oxide (ITO) or indium zinc oxide (IZO); a conductor-containing resin that contains an electrical conductor, such as a silver nanowire or a conductive particle; and a metal thin film, such as a silver thin film. Each of first electrode 20 and second electrode 50 may have a single-layer configuration that includes one of the above materials. Alternatively, each of first electrode 20 and second electrode 50 may have a multi-layer configuration that includes the above materials (for example, a multi-layer configuration that includes the transparent metallic oxide and the metal thin film).

First electrode 20 is disposed on first substrate 10. To be more specific, first electrode 20 is interposed between first substrate 10 and uneven layer 30. On the other hand, second electrode 50 is disposed on refractive-index adjustment layer 40. To be more specific, second electrode 50 is interposed between second substrate 60 and refractive-index adjustment layer 40.

As shown in FIG. 1, second electrode 50 includes a plurality of pattern electrodes 51 that are aligned in a Z axis direction (a first direction). Separation region 52 is formed between pattern electrodes 51 that are adjacent to each other among the plurality of pattern electrodes 51. More specifically, second electrode 50 is divided into the plurality of pattern electrodes 51 via separation regions 52. Each of the plurality of pattern electrodes 51 is formed as a segmented electrode that is functionally divided. In the present embodiment, second electrode 50 includes seven pattern electrodes 51. It should be noted that first electrode 20 is a single electrode film (a solid electrode) formed in a manner to cover the plurality of pattern electrodes 51 of second electrode 50.

Each of the plurality of pattern electrodes 51 included in second electrode 50 is formed in a shape of a strip elongated in a second direction that crosses the first direction. Thus, each of the plurality of separation regions 52 is also formed in a shape of a strip elongated in the second direction that crosses the first direction. To be more specific, each of the plurality of pattern electrodes 51 and the plurality of separation regions 52 has a long rectangle shape in a plan view and is elongated in an X axis direction.

Moreover, the plurality of pattern electrodes 51 are electrically connected to each other. As shown in FIG. 1, each of the plurality of pattern electrodes 51 is connected to an adjacent one of the plurality of pattern electrodes 51 via one of longitudinal end portions of pattern electrode 51. More specifically, all the plurality of pattern electrodes 51 are connected to each other, by connecting respective ones of longitudinal end portions of the plurality of pattern electrodes 51 via connection electrodes 53 elongated in the Z axis direction.

Areas of the plurality of pattern electrodes 51 vary successively in the Z axis direction. More specifically, the areas of the plurality of pattern electrodes 51 gradually decrease in the Z axis direction. Even more specifically, the areas of the plurality of pattern electrodes 51 gradually decrease in a phased manner (by gradation) in the Z axis direction.

As shown in FIG. 1 and FIG. 2, separation regions 52 between pattern electrodes 51 adjacent to each other have the same width (the same length in the Z axis direction). However, separation regions 52 may have different widths.

First electrode 20 and second electrode 50 having the configurations as described above are electrically connected to power supply 2 shown in FIG. 1. For example, second electrode 50 is connected to power supply 2 via lead line 3, as shown in FIG. 4. More specifically, a part of second electrode 50 is drawn out to an end portion of second substrate 60, and this drawn-out part is used as an electrode pad which is then connected to lead line 3. Lead line 3 and second electrode 50 are connected to each other electrically and physically via an electrically-conductive adhesive, such as solder. It should be noted that, although not illustrated, first electrode 20 is also connected to power supply 2 via, for example, a lead line. With this, first electrode 20 and second electrode 50 are applied with a predetermined voltage by electric power supplied from power supply 2.

### [Uneven Layer]

As shown in FIG. 2 and FIG. 3, uneven layer 30 is disposed on first electrode 20. More specifically, uneven layer 30 is interposed between first electrode 20 and refractive-index adjustment layer 40. In the present embodiment, uneven layer 30 is in contact with first electrode 20 and refractive-index adjustment layer 40.

Uneven layer 30 is light-transmissive and allows the incident light to pass through uneven layer 30. To be more specific, the light entering uneven layer 30 from first electrode 20 passes through uneven layer 30 and then enters refractive-index adjustment layer 40.

Uneven layer 30 is an uneven structure having an uneven surface that is formed by a repetition of a plurality of projections 31. To be more specific, uneven layer 30 has a configuration in which the plurality of projections 31 projecting toward refractive-index adjustment layer 40 are aligned.

The plurality of projections 31 are formed in stripes. To be more specific, the plurality of projections 31 are in the same shape and arranged at equally spaced intervals in the Z axis direction. Each of the plurality of projections 31 is triangular in cross section and has nearly a shape of an elongated triangular prism.

Each of the plurality of projections 31 is in micro- or nano-order size. Each of the plurality of projections 1 has a height (a recess depth) of, for example, 100 nm to 100 μm. However, a range of the height is not limited to this. Moreover, an interval between apexes of projections 31 adjacent to each other (a projection-recess pitch) is, for example, 100 nm to 100 μm. However, a range of the interval is not limited to this.

Each of the plurality of projections 31 has an inclined surface that is inclined at a predetermined angle of inclination with respect to a thickness direction. The inclined surface of projection 31 is a boundary surface (an interface) between uneven layer 30 and refractive-index adjustment layer 40. Light traveling from uneven layer 30 to refractive-index adjustment layer 40 is totally reflected off the inclined surface of projection 31 depending on a refractive index difference between uneven layer 30 and refractive-index adjustment layer 40, or passes through uneven layer 30 and refractive-index adjustment layer 40 without being reflected. In other words, the inclined surface of projection 31 functions as a light reflecting surface (a total reflecting surface) or a light transmitting surface.

Uneven layer 30 may be an insulation layer that is insulating, or a conductive layer that is electrically conductive.

Suppose that uneven layer 30 is an insulation layer. In this case, examples of a material of uneven layer 30 include a resin material that is light-transmissive, such as an acrylic resin, an epoxy resin, or a silicon resin. Moreover, uneven layer 30 in this case can be formed by, for example, molding or nanoimprinting. As an example, the material of uneven layer 30 is an acrylic resin having a refractive index of 1.5.

Suppose that uneven layer 30 is a conductive layer. In this case, examples of a material of uneven layer 30 include a conductive polymer and a conductor-containing resin. As an example of a conductive polymer, PEDOT may be used. As an example of a conductor-containing resin, a mixed material that includes a conductor and a resin containing this conductor (i.e., conductor-containing resin) may be used. More specifically, the conductor may be, for example, a silver nanowire, and the resin may be, for example, cellulose or acrylic.

It should be noted that when uneven layer 30 is a conductive layer, a material of uneven layer 30 may be the same as that of first electrode 20. In this case, uneven layer 30 and first electrode 20 may be formed as a one-piece structure by integral molding or may be formed into separate structures. Here, note that the uneven surface of uneven layer 30 can be formed more easily when uneven layer 30 and first electrode 20 are formed into the separate structures.

The plurality of projections 31 are disposed in a manner that projections 31 adjacent to each other contact each other without leaving clearance in root portions (or more specifically, disposed at zero pitch). However, the plurality of projections 31 may be disposed in a manner that projections 31 adjacent to each other have clearance between the root portions and thus do not contact each other.

### [Refractive-Index Adjustment Layer]

As shown in FIG. 2 and FIG. 3, refractive-index adjustment layer 40 is disposed on uneven layer 30. More specifically, refractive-index adjustment layer 40 is interposed between first electrode 20 and second electrode 50.

In refractive-index adjustment layer (refractive-index change layer) 40, the refractive index in a visible light region is adjustable. Refractive-index adjustment layer 40 is formed using a material that varies in refractive index (a refractive-index variable material) with an application of an electric field. In the present embodiment, refractive-index adjustment layer 40 is formed using a liquid crystal material that contains a liquid crystal molecule having birefringence and an electric field response function. More specifically, a liquid crystal material is used as the refractive-index variable material. Examples of such a liquid crystal material include a nematic liquid crystal and a cholesteric liquid crystal in which a liquid crystal molecule has a shape of a rod. An orientation state of the liquid crystal molecules changes with the application of the electric field, and the refractive index of the liquid crystal material thereby changes. Moreover, in the present embodiment, a negative liquid crystal containing a liquid crystal molecule in the shape of a rod is used as the liquid crystal material. Here, the liquid crystal molecule has a lower permittivity in a long axis direction and a higher permittivity in a direction perpendicular to the long axis direction. This liquid crystal material has an ordinary-light refractive index (no) of 1.5 and an extraordinary-light refractive index (ne) of 1.7, for example.

Refractive-index adjustment layer 40 is applied with an electric field in response to an application of a voltage to first electrode 20 and second electrode 50. Thus, by the control of the voltage to be applied to first electrode 20 and second electrode 50, the electric field to be applied to refractive-index adjustment layer 40 changes. With this, the orientation state of the liquid crystal molecules changes and the refractive index of refractive-index adjustment layer 40 thereby changes. More specifically the refractive index of refractive-index adjustment layer 40 (the liquid crystal) changes into one of the following two: a refractive index (a first refractive index) that is the same as or near a refractive index of uneven layer 30; and a refractive index (a second refractive index) that is significantly different from the refractive index of uneven layer 30.

This change in the refractive index of refractive-index adjustment layer changes an optical action of optical device 1. To be more specific, the incident light is allowed to pass through optical device 1 with or without deflection. As described, optical device 1 is an active optical control device that can change the optical action by controlling refractive index matching between uneven layer 30 and refractive-index adjustment layer 40 using the electric field.

To be more specific, optical device 1 can switch between the following, in response to the change m the refractive index of refractive-index adjustment layer 40: a transparent state (a transparent mode) that allows the incident light to pass though optical device 1 without changing the traveling direction of the incident light; and a light distribution state (a light distribution mode) that allows the incident light to pass through optical device 1 after changing the traveling direction of the incident light (or more specifically, after distributing the incident light). More specifically, when a refractive index difference is small between refractive-index adjustment layer 40 and uneven layer 30 (such as when the refractive index of refractive-index adjustment layer 40 is the same as or near the refractive index of uneven layer 30), refractive-index adjustment layer 40 achieves the transparent state. On the other hand, when the refractive index difference is large between refractive-index adjustment layer and uneven layer 30, refractive-index adjustment layer 40 achieves the light distribution state.

As an example, suppose that the refractive index of uneven layer 30 is 1.5. In this case, when the electric field is not applied (that is, in the case of the transparent state), the refractive index of refractive-index adjustment layer can be 1.5. When, on the other hand, the electric field is applied (that is, in the case of the light distribution state), the refractive index of refractive-index adjustment layer 40 can be about 1.7.

Here, the negative liquid crystal having the ordinary-light refractive index of 1.5 and the extraordinary-light refractive index of 1.7 is used as the material of refractive-index adjustment layer 40. On this account, when first electrode 20 and second electrode 50 are not applied with a voltage, the refractive index of refractive-index adjustment layer 40 is 1.5. On the other hand, when first electrode 20 and second electrode 50 are applied with a voltage, the refractive index of refractive-index adjustment layer 40 is 1.7. Here, with the refractive index difference (=0.2) between uneven layer 30 and refractive-index adjustment layer 40 during the voltage application, the light incident on optical device 1 is totally reflected off the interface between uneven layer 30 and refractive-index adjustment layer 40 (i.e., the inclined surface of projection 31) and the traveling direction of the incident light can be thus changed. More specifically, optical device 1 can achieve the light distribution state.

It should be noted that refractive-index adjustment layer 40 may be applied with the electric field from an alternating-current power source or from a direct-current power source. When the alternating-current power source is used, a voltage waveform may be a sinusoidal waveform or a rectangular waveform.

### [Usage Example and Optical Action of Optical Device]

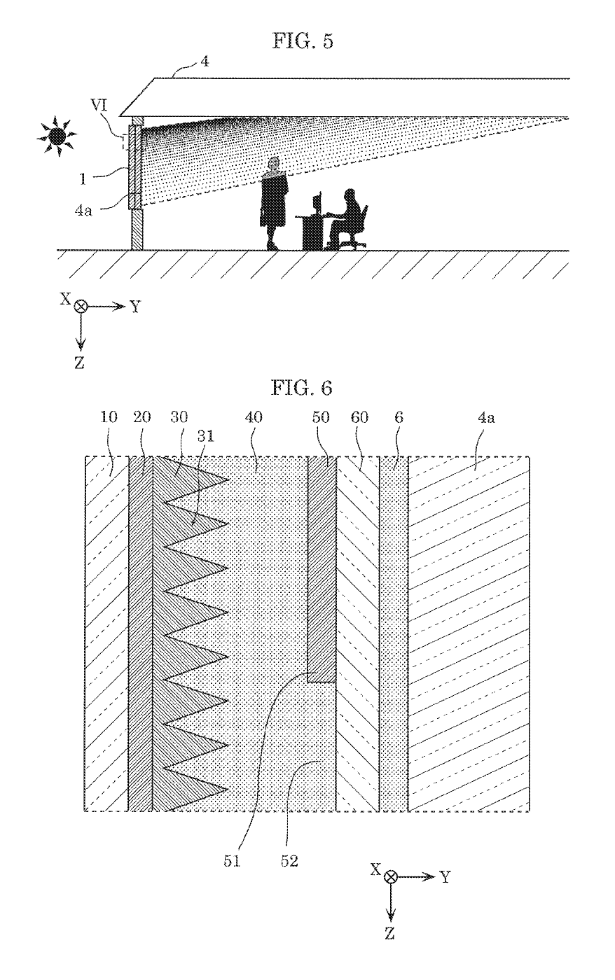

Next, a usage example of optical device 1 according to Embodiment 1 is described, with reference to FIG. 5 and FIG. 6. FIG. 5 is a diagram showing an example of using optical device 1 according to Embodiment 1. FIG. 6 is an enlarged cross-sectional view of region VI enclosed by a dashed line shown in FIG. 5.

As shown in FIG. 5, optical device 1 is implemented as a window provided with a light distribution function when mounted to window 4a of building 4. As shown in FIG. 6, optical device 1 is bonded to window 4a via sticky layer 6, for example. In this case, optical device 1 is mounted to window 4a in a posture in which each of main surfaces of first substrate 10 and second substrate 60 is parallel to the vertical direction (i.e., the Z axis direction) (or more specifically, mounted to window 4a in an upright posture). In FIG. 6, optical device 1 is disposed on a surface of window 4a on an outdoor side. However, optical device 1 may be disposed on a surface of window 4a on an indoor side.

By mounting optical device 1 to window 4a in this way, pattern electrode 51 having the smallest area among the plurality of pattern electrodes 51 of optical device 1 is formed in a position corresponding to a lowermost portion of window 4a. In other words, pattern electrode 51 having the largest area among the plurality of pattern electrodes 51 is formed in a position corresponding to an uppermost portion of window 4a.

Moreover, as shown in FIG. 6, optical device 1 is disposed in a manner that first substrate 10 is located on the outdoor side and that second substrate 60 is located on the indoor side. To be more specific, optical device 1 shown in FIG. 6 is disposed in a manner that first substrate 10 is located on a light-entering side and that second substrate 60 is located on a light-emitting side. Thus, optical device 1 allows light entering from first substrate 10 to pass through optical device 1 and thus to be emitted from second substrate 60 to enter window 4a.

In the present embodiment, second electrode 50 is divided into the plurality of pattern electrodes 51 via separation regions 52. On this account, a position that opposes first electrode 20 includes a region in which second electrode 50 (pattern electrode 51) is present and a region in which second electrode 50 (pattern electrode 51) is not present. For this reason, the light entering optical device 1 is subjected to the optical action that is different depending on whether the light passes through the region in which second electrode 50 (pattern electrode 51) is present or the region in which second electrode 50 (pattern electrode 51) is not present.

To be more specific, in the region in which pattern electrode 51 is present as shown in FIG. 3, the light distribution state is achieved in response to the application of a voltage to first electrode 20 and second electrode 50 as described above. In other words, the light passing through the region in which pattern electrode 51 is present is subjected to the optical action by which the traveling direction of the light is changed. As a result, the light is distributed.

Even more specifically, when the refractive index of uneven layer 30 is 1.5 and a voltage is applied, the refractive index of refractive-index adjustment layer 40 is 1.7 in the region in which pattern electrode 51 is present. Thus, the light passing through a lower surface of projection 31 of uneven layer 30 and then entering refractive-index adjustment layer 40 is totally reflected off an upper surface of projection 31. For example, the light incident on optical device 1 in an obliquely downward direction and then on the upper surface of projection 31 at a critical angle or larger is totally reflected off the upper surface of projection 31 and thus changed in the traveling direction to proceed in an obliquely upward direction.

On the other hand, the electric field is not applied to refractive-index adjustment layer 40 in the region in which pattern electrode 51 is not present (i.e., in the region in which separation region 52 is present). Thus, the refractive index of refractive-index adjustment layer 40 remains at about 1.5. As a result of this, the light distribution state is not achieved. More specifically, the light passing through the region in which pattern electrode 51 is not present travels in a straight line without being subjected to the optical action by which the traveling direction is changed.

Even more specifically, since the refractive index of refractive-index adjustment layer 40 is 1.5, there is no refractive index difference between uneven layer 30 and refractive-index adjustment layer 40. Thus, the light entering optical device 1 travels in a straight line without being totally reflected off the upper surface of projection 31 of uneven layer 30.

### Advantageous Effect

With optical device 1 according to the present embodiment described thus far, second electrode 50 includes the plurality of pattern electrodes 51 aligned in the first direction (for example, the Z axis direction). Moreover, separation region 52 is formed between pattern electrodes 51 that are adjacent to each other among the plurality of pattern electrodes 51. The areas of the plurality of pattern electrodes 51 vary successively in a direction in which the plurality of pattern electrodes 51 are aligned (i.e., in the first direction). More specifically, gradations can be achieved in the areas of the plurality of pattern electrodes 51 in the direction in which the plurality of pattern electrodes 51 are aligned (i.e., in the first direction).

With this, even when the widths of separation regions 52 (lengths in the first direction) between pattern electrodes 51 adjacent to each other are uniform, or more specifically, even when separation regions 52 have the same width, an abundance ratio of separation regions 52 can be varied successively in the first direction.

As a result, even when optical device 1 distributes outside light and introduces the outside light into a room, an amount of light that is distributed (an amount of distributed light) can be varied successively, as shown in FIG. 5. Thus, the gradations can be achieved in the amount of distributed light. With this, even when a person crosses the boundary portion of the distributed light to the light region, a sudden dazzled feeling can be suppressed. Therefore, a feeling of discomfort caused at the boundary portion of the distributed light can be reduced.

Moreover, the areas of the plurality of pattern electrodes 51 decrease gradually in the first direction (the Z axis direction) in the present embodiment.

With this configuration, when optical device 1 distributes the outside light and introduces the outside light into the room, the amount of distributed light can be decreased toward the boundary portion of the distributed light. On this account, the amount of light can be reduced in the boundary portion of the distributed light. Thus, the feeling of discomfort caused at the boundary portion of the distributed light can be further reduced.

For example, when optical device 1 is mounted to window 4a as shown in FIG. 5, the areas of the plurality of pattern electrodes 51 decrease toward a lower portion of window 4a. To be more specific, pattern electrode 51 having the smallest area among the plurality of pattern electrodes 51 is formed in the position corresponding to the lowermost portion of window 4a.

With this configuration, when optical device 1 distributes the outside light toward a ceiling side, the amount of distributed light can be reduced in an obliquely downward direction in a space region through which the distributed light passes. Thus, the amount of light can be reduced in the boundary portion. As a result, the feeling of discomfort caused at the boundary portion of the distributed light can be further reduced.

Furthermore, the plurality of pattern electrodes 51 are electrically connected to each other in the present embodiment.

With this configuration, a voltage can be applied to the plurality of pattern electrodes 51 at the same time. Thus, the gradations can be easily achieved in the amount of distributed light.

Moreover, each of the plurality of pattern electrodes 51 is formed in the shape of a strip elongated in the X axis direction in the present embodiment. Each of the plurality of pattern electrodes 51 is connected to an adjacent one of the plurality of pattern electrodes 51 via one of the longitudinal end portions of pattern electrode 51.

With this configuration, the gradations can be easily achieved in the amount of distributed light corresponding to the respective areas of the plurality of pattern electrodes 51.

### Variation 1 of Embodiment 1

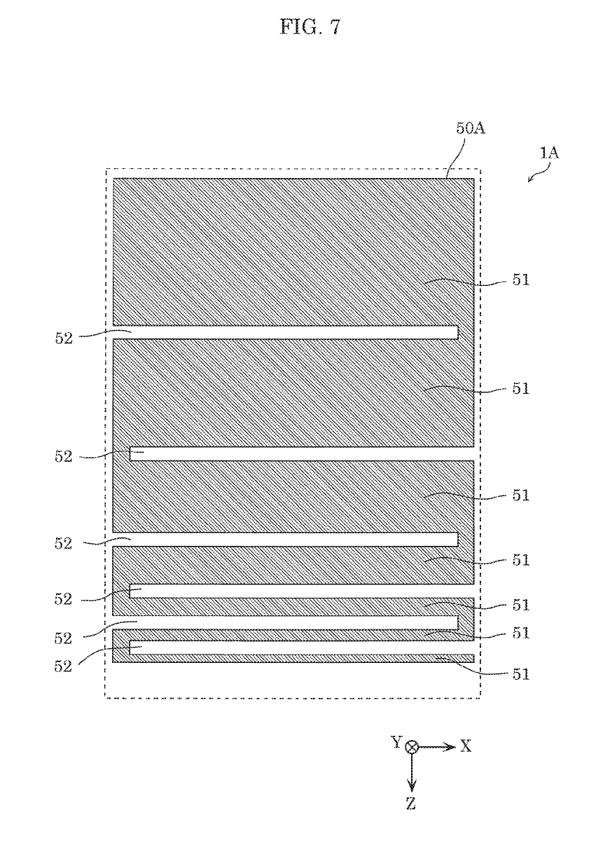

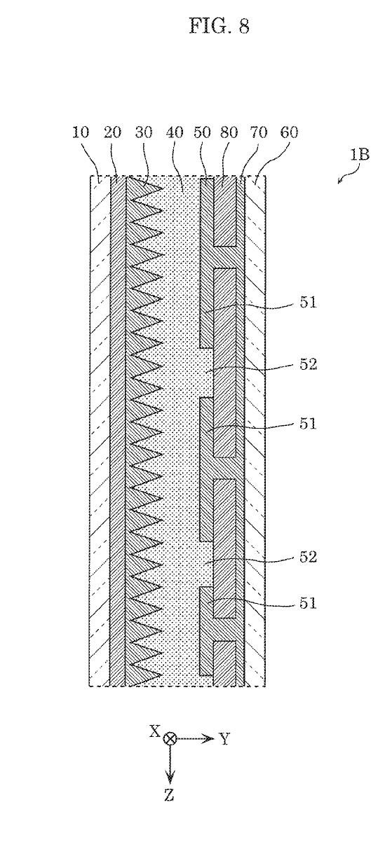

FIG. 7 is a diagram showing a shape of second electrode 50A included in optical device 1A according to Variation 1 of Embodiment 1. It should be noted that, to simply show the shape of second electrode 50A, an area in which second electrode 50A is disposed is hatched for the sake of convenience in FIG. 2.

In Embodiment 1 described above, each of the plurality of pattern electrodes 51 of second electrode 50 is connected to an adjacent one of the plurality of pattern electrodes 51 via one of the longitudinal end portions of pattern electrode 51. However, in the present variation, a plurality of pattern electrodes 51 of second electrode 50A are connected to each other via respective ones of longitudinal end portions of the plurality of pattern electrodes 51 in a manner to form a serpentine shape as a whole. More specifically, the plurality of pattern electrodes 51 are connected to each other in a manner that series connection can be achieved when each of the plurality of pattern electrodes 51 itself is used as a load resistance.

In this way, the plurality of pattern electrodes 51 are connected to each other to form the serpentine shape in the present variation. With this configuration, a voltage drop is caused corresponding to a resistance of pattern electrode 51 in a wiring direction. Thus, the gradations in the amount of distributed light can be increased more than the variations in the areas of pattern electrodes 51. As a result of this, the feeling of discomfort caused at the boundary portion of the distributed light can be further reduced.

### Variation 2 of Embodiment 1

FIG. 8 is an enlarged cross-sectional view of optical device 1B according to Variation 2 of Embodiment 1.

As shown in FIG. 8, optical device 1B according to the present variation includes third electrode 70 that opposes first substrate 10, in addition to the configuration of optical device 1 according to Embodiment 1. Moreover, each of a plurality of pattern electrodes 51 is electrically connected to third electrode 70.

Third electrode 70 and second electrode 50 that is divided into segmented electrodes are formed in a manner to sandwich insulation layer 80. In other words, third electrode 70 and second electrode 50 are disposed via insulation layer 80. Third electrode 70 is a single electrode film (a solid electrode) formed in a manner to cover the plurality of pattern electrodes 51 of second electrode 50. Third electrode 70 and each of the plurality of pattern electrodes 51 are connected via a through hole formed in insulation layer 80. It should be noted that third electrode 70 is a transparent conductive layer formed from, for example, ITO, and may be formed using the same material as that of second electrode 50 for example.

In this way, the electrical interconnection of the plurality of pattern electrodes 51 via third electrode 70 allows the plurality of pattern electrodes 51 to be connected in parallel in the present variation. With this, gradations in the amount of distributed light can correspond to the areas of the plurality of pattern electrodes 51. More specifically, the gradations in the amount of distributed light can be controlled by the areas themselves of the plurality of pattern electrodes 51.

### Variation 3 of Embodiment 1

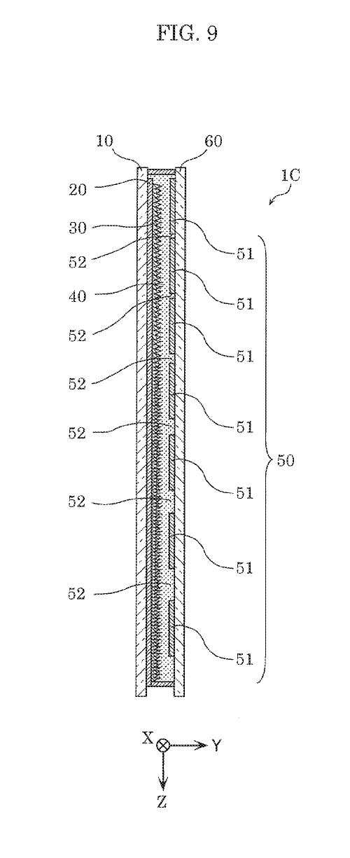

FIG. 9 is an enlarged cross-sectional view of optical device 1C according to Variation 3 of Embodiment 1.

In Embodiment 1 described above, the gradations can be achieved in the amount of distributed light by the successive variations in the areas of the plurality of pattern electrodes 51 in the Z axis direction. In the present variation, on the other hand, gradations in the amount of distributed light can be achieved by successive variations in areas of a plurality of separation regions 52 in the Z axis direction.

To be more specific, by the successive variations in the areas of the plurality of separation regions 52 in the Z axis direction, the gradations can be achieved in the areas of the plurality of separation regions 52 in the Z axis direction. This allows the gradations to be achieved in the amount of distributed light in the Z axis direction.

With this configuration, optical device 1C according to the present variation can also achieve the same advantageous effect as that achieved by optical device 1 according to Embodiment 1 described above. More specifically, suppose that optical device 1C distributes outside light and introduces the outside light into a room, as in the case of optical device 1 shown in FIG. 5. In this case, even when a person crosses a boundary portion of the distributed light to a light region, a sudden dazzled feeling can be suppressed. Therefore, a feeling of discomfort caused at the boundary portion of the distributed light can be reduced.

Moreover, the areas of the plurality of separation regions 52 gradually increase in the Z axis direction in the present variation. More specifically, the areas of the plurality of separation regions 52 gradually decrease in a phased manner (by gradation) in the Z axis direction.

With this configuration, when optical device 1C distributes the outside light and introduces the outside light into the room, the amount of distributed light can be decreased toward the boundary portion of the distributed light. On this account, the amount of light can be reduced in the boundary portion. Thus, the feeling of discomfort caused at the boundary portion of the distributed light can be further reduced.

For example, when optical device 1C is mounted to window 4a as in the case of optical device 1 shown in FIG. 5, the areas of the plurality of separation regions 52 decrease toward a lower portion of window 4a. To be more specific, separation region 52 having the largest area among the plurality of separation regions 52 is formed in the position corresponding to the lowermost portion of window 4a.

With this configuration, when optical device 1C distributes the outside light toward a ceiling side, the amount of distributed light can be reduced in an obliquely downward direction in a space region through which the distributed light passes. Thus, the amount of light can be reduced in the boundary portion. As a result, the feeling of discomfort caused at the boundary portion of the distributed light can be further reduced.

It should be noted that although the plurality of pattern electrodes 51 have the same width (the same length in the Z axis direction) in the present variation, the plurality of pattern electrodes 51 may have different widths.

### Variation 4 of Embodiment 1

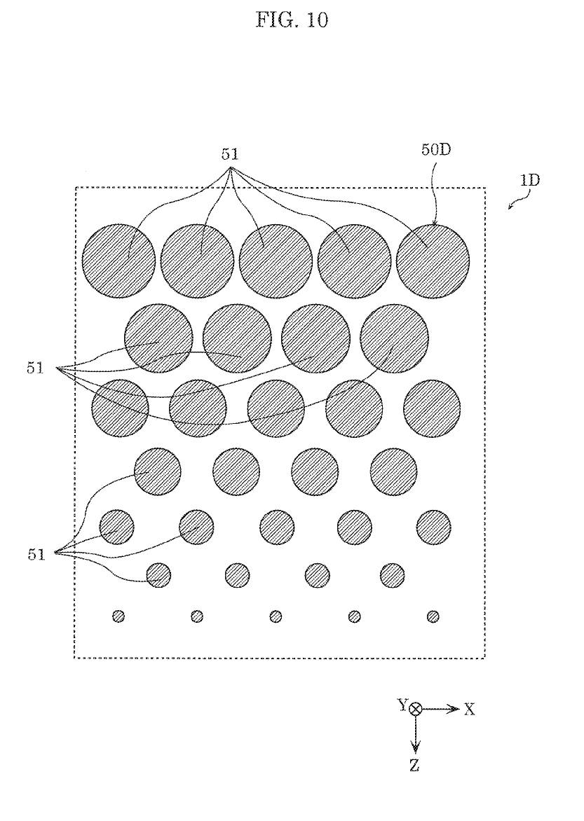

FIG. 10 is a diagram showing a shape of second electrode 50D included in optical device 1D according to Variation 4 of Embodiment 1. It should be noted that, to simply show the shape of second electrode 50D, an area in which second electrode 50D is disposed is hatched for the sake of convenience in FIG. 10.

In Embodiment 1 described above, each of the plurality of pattern electrodes 51 of second electrode 50 is formed in the shape of a strip elongated in the Z axis direction. In the present variation, on the other hand, each of a plurality of pattern electrodes 51 of second electrode 50D is divided into a plurality of segmented electrodes in the Z axis direction. More specifically, as shown in FIG. 10, second electrode 50D according to the present variation includes a plurality of pattern electrodes 51 which are in shapes of dots and scattered in the Z and X directions.

Optical device 1D according to the present variation can also achieve the same advantageous effect as that achieved by optical device 1 according to Embodiment 1 described above. More specifically, suppose that optical device 1D distributes outside light and introduces the outside light into a room. In this case, even when a person crosses a boundary portion of the distributed light to a light region, a sudden dazzled feeling can be suppressed. Therefore, a feeling of discomfort caused at the boundary portion of the distributed light can be reduced.

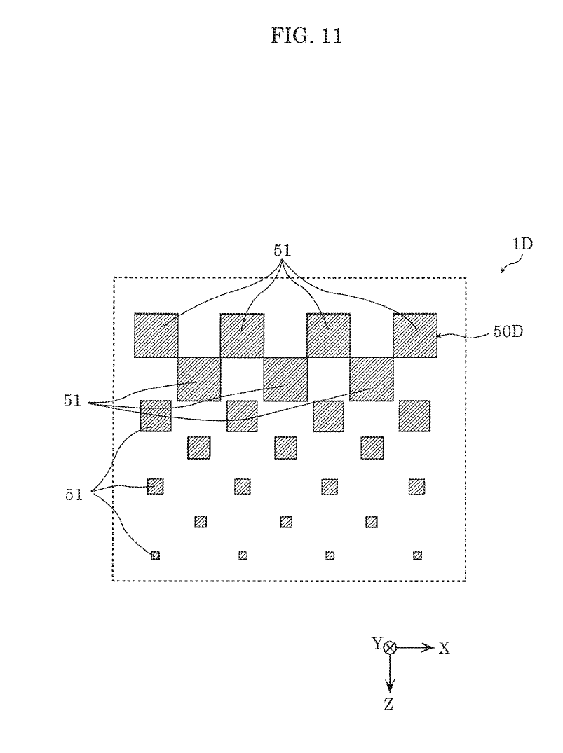

In the present variation, the shapes of the plurality of pattern electrodes 51 of second electrode 50D are not limited to the round dots shown in FIG. 10. The shapes may be rectangular dots as shown in FIG. 11. In this case, the plurality of pattern electrodes 51 may be arranged in a matrix or in a checkered pattern as shown in FIG. 11.

### Embodiment 2

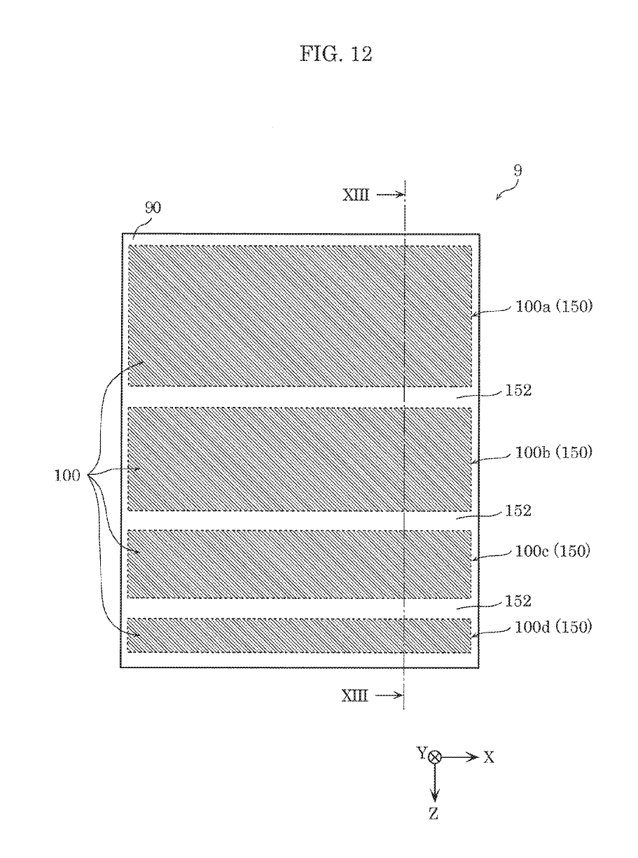

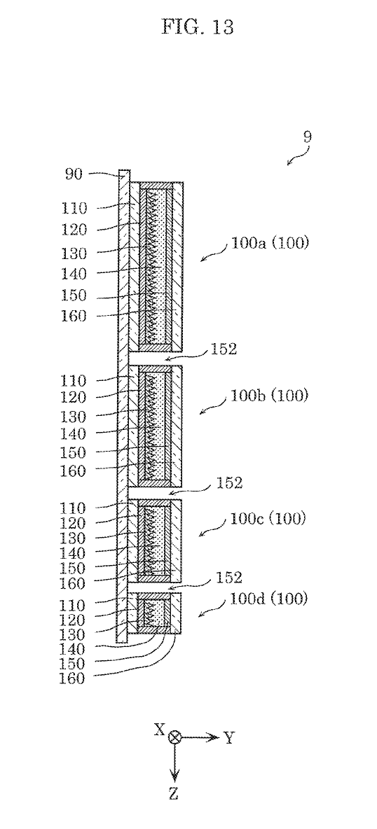

Hereinafter, a configuration of optical device 9 according to Embodiment 2 is described, with reference to FIG. 12 and FIG. 13. FIG. 12 is a plan view showing optical device 9 viewed from the front side, according to Embodiment 2. FIG. 13 is a cross-sectional view of optical device 9 along XIII-XIII line shown in FIG. 12.

In Embodiment 1 described above, optical device 1 is formed by dividing second electrode 50 that is included in a single optical element. In the present embodiment, on the other hand, optical device 9 includes a plurality of optical elements which have respective second electrodes 150 in different sizes.

To be more specific, as shown in FIG. 12 and FIG. 13, optical device 9 includes the following: supporting substrate 90; and a plurality of optical elements 100 which are aligned on supporting substrate 90 in a Z axis direction (a first direction). In optical device 9 according to the present embodiment, areas of the plurality of optical elements 100 in a plan view vary successively in a direction in which the plurality of optical elements 100 are aligned (i.e., in the Z axis direction).

The following describes structural members of optical device 9 in more detail, with reference to FIG. 12 and FIG. 13.

Supporting substrate 90 is a substrate that supports the plurality of optical elements 100. Supporting substrate 90 is a light-transmissive substrate that is light-transmissive. As is the case with first substrate 10 and second substrate 60 in Embodiment 1, a glass substrate or a transparent resin substrate may be used as supporting substrate 90.

A substrate used for supporting substrate 90 is not limited to a rigid substrate, and may be a flexible substrate having flexibility in a form of a film or a sheet. Moreover, supporting substrate 90 is in a shape of, for example, a quadrangle such as a square or a rectangle in a plan view. However, the shape of supporting substrate 90 is not limited to this, and may be a circle or a polygon other than a quadrangle. Thus, any shape can be adopted.

The plurality of optical elements 100 are affixed to supporting substrate 90 via, for example, an adhesive. In the present embodiment, the plurality of optical elements 100 includes four optical elements, which are first optical element 100a, second optical element 100b, third optical element 100c, and fourth optical element 100d.

Each of the plurality of optical elements 100 (i.e., first optical element 100a, second optical element 100b, third optical element 100c, and fourth optical element 100d) includes first substrate 110, first electrode 120, uneven layer 130, refractive-index adjustment layer 140, second electrode 150, and second substrate 160.

First substrate 110 and second substrate 160 included in each of the plurality of optical elements 100 are light-transmissive substrates. Substrates formed using the same materials as those of first substrate 10 and second substrate 60 in Embodiment 1 may be used as first substrate 110 and second substrate 160. In the present embodiment, first substrate 110 and second substrate 160 are formed using the same material and have the same size and the same shape in a plan view.

Moreover, as is the case with first electrode 20 and second electrode 50 in Embodiment 1, first electrode 120 and second electrode 150 included in each of the plurality of optical elements 100 are formed to be an electrical pair that can apply an electric field to refractive-index adjustment layer 140. Materials used for first electrode 120 and second electrode 150 may be the same as those of first electrode 20 and second electrode 50 in Embodiment 1. In the present embodiment, first electrode 120 and second electrode 150 are formed using the same material and have the same size and the same shape in a plan view.

First electrode 120 included in each of the plurality of optical elements 100 is disposed on first substrate 110. To be more specific, first electrode 120 is interposed between first substrate 110 and uneven layer 130. On the other hand, second electrode 150 is disposed on refractive-index adjustment layer 140. To be more specific, second electrode 150 is interposed between second substrate 160 and refractive-index adjustment layer 140.

Unlike the case described in Embodiment 1, second electrode 150 included in each of the plurality of optical elements 100 is not divided in the present embodiment. However, second electrodes 150 of the plurality of optical elements 100 have mutually different sizes in a plan view. To be more specific, areas of second electrodes 150 of the plurality of optical elements 100 vary successively in the direction in which the plurality of optical elements 100 are aligned (i.e., in the Z axis direction).

Uneven layer 130 included in each of the plurality of optical elements 100 is disposed on first electrode 120. To be more specific, uneven layer 130 is interposed between first electrode 120 and refractive-index adjustment layer 140. A configuration of uneven layer 130 is the same as that of uneven layer in Embodiment 1. Thus, uneven layer 130 has the configuration in which a plurality of projections projecting toward refractive-index adjustment layer 140 are aligned.

Refractive-index adjustment layer 140 included in each of the plurality of optical elements 100 is disposed on uneven layer 130. To be more specific, refractive-index adjustment layer 140 is interposed between first electrode 120 and second electrode 150. A configuration of refractive-index adjustment layer 140 is the same as that of refractive-index adjustment layer 140 in Embodiment 1.

Optical device 9 having the configuration described above includes separation region 152 formed between two optical elements 100 that are adjacent to each other among the plurality of optical elements 100. In other words, separation region 152 separates two optical elements 100 that are adjacent to each other. More specifically, separation region 152 is present between first optical element 100a and second optical element 100b, between second optical element 100b and third optical element 100c, and between third optical element 100c and fourth optical element 100d. In FIG. 12 and FIG. 13, widths of the plurality of separation regions 152 (lengths in the Z axis direction) are uniform, or more specifically, the plurality of separation regions 152 have the same width.

Optical device 9 having the configuration described above can be used as a window provided with a light distribution function, as with optical device 1 shown in FIG. 5 and FIG. 6 in Embodiment 1. Moreover, optical device 9 operates in the same manner as optical device 1 according to Embodiment 1 and achieves the same optical action as that achieved by optical device 1 according to Embodiment 1.

As described thus far, optical device 9 according to the present embodiment includes the plurality of optical elements 100 aligned in the first direction (for example, the Z axis direction). Moreover, the areas of the plurality of optical elements 100 in the plan view vary successively in the direction in which the plurality of optical elements 100 are aligned (i.e., in the first direction). To be more specific, gradations can be achieved in the areas of the plurality of optical elements 100 in the direction in which the plurality of optical elements 100 are aligned (i.e., in the first direction). As a result, although second electrode 150 included in each of the plurality of optical elements 100 is not divided, the different areas of the plurality of optical elements 100 allows gradations to be achieved in the areas of second electrodes 150 of the plurality of optical elements 100 in the direction in which the plurality of optical elements 100 are aligned (i.e., in the first direction).

With this, even when the widths of separation regions 152 are uniform (or more specifically, even when separation regions 152 have the same width), an abundance ratio of separation regions 52 can be successively varied in the direction in which the plurality of optical elements 100 are aligned (i.e., in the first direction).

As a result, the same advantageous effect as that achieved by optical device 1 according to Embodiment 1 can be obtained. More specifically, when optical device 9 distributes outside light and introduces the outside light into a room, the amount of light that is distributed (the amount of distributed light) can be successively varied. Thus, gradations can be achieved in the amount of distributed light. With this, even when a person crosses a boundary portion of the distributed light to a light region, a sudden dazzled feeling can be suppressed. Therefore, a feeling of discomfort caused at the boundary portion of the distributed light can be reduced.

Moreover, in the present embodiment, the areas of the plurality of second electrodes 150 corresponding to the plurality of optical elements 100 gradually decrease in the direction in which the plurality of optical elements 100 are aligned (i.e., in the Z axis direction). With this, as in the case of optical device 1 according to Embodiment 1, the feeling of discomfort caused at the boundary portion of the distributed light can be further reduced.

In the present embodiment, the widths of separation region 152 are uniform and the areas of the plurality of optical elements 100 in the plan view are successively varied. However, the widths and the area variations are not intended to be limiting. For example, the areas of the plurality of optical elements 100 in the plan view (the areas of second electrodes 150 in the plan view) may be uniform, and the areas of the plurality of separation regions 152 may vary successively in the direction in which the plurality of optical elements 100 are aligned. Moreover, both the areas of the plurality of optical elements 100 in the plan view and the areas of the plurality of separation regions 152 may vary successively in the direction in which the plurality of optical elements 100 are aligned. To be more specific, at least one of the areas of the plurality of optical elements 100 in the plan view and the areas of the plurality of separation regions 152 may vary successively in the direction in which the plurality of optical elements 100 are aligned (i.e., in the first direction).

Furthermore, Variations 1 to 4 of Embodiment 1 can be applied to optical device 9 according to the present embodiment.

### Other Variations, Etc.

Although the optical device according to the present invention has been described based on the embodiments and variations, the present invention is not limited to the embodiments and variations described above.

In Embodiment 1 described above for example, only the areas of the plurality of pattern electrodes 51, out of the areas of the plurality of pattern electrodes 51 and the areas of the plurality of separation regions 52, vary successively. Moreover, in Variation 3 above, only the areas of the plurality of separation regions 52, out of the areas of the plurality of pattern electrodes 51 and the areas of the plurality of separation regions 52, vary successively. However, these are not intended to be limiting. Both the areas of the plurality of pattern electrodes 51 and the areas of the plurality of separation regions 52 may vary successively. More specifically, at least one of the areas of the plurality of pattern electrodes 51 and the areas of the plurality of separation regions 52 may vary successively.

Furthermore, in Embodiment 1 described above, each of second electrodes 50 to 50D includes the plurality of pattern electrodes 51. However, first electrode 20 may include a plurality of pattern electrodes, as with second electrodes 50 to 50D. In this case, the second electrode may be a single electrode film, instead of the plurality of pattern electrodes. To be more specific, one of the first electrode and the second electrode may include the plurality of pattern electrodes, and the other one of the first electrode and the second electrode may be the single electrode film that covers the aforementioned plurality of pattern electrodes. It should be noted that, in the case where gradations can be achieved in the amount of distributed light in a predetermined direction, both the first electrode and the second electrode may include the plurality of pattern electrodes.

Moreover, first electrode 20 in Embodiment 1 is formed as the single electrode film (the solid electrode) to cover the plurality of pattern electrodes 51 included in second electrode 50. However, this is not intended to be limiting. For example, as in Embodiment 2, first electrode 20 may be formed in the same shape as that of second electrode 50. More specifically, first electrode 20 may include a plurality of pattern electrodes, as with second electrode 50.

Furthermore, each of the plurality of projections 31 included in uneven layers 30 and 30a to 30d is triangular in cross section and has nearly the shape of an elongated triangular prism, according to Embodiments 1 and 2 described above. However, the shape of projection 31 is not limited to this. For example, each of the plurality of projections 31 included in uneven layers 30 and 30a to 30d may be trapezoidal in cross section and have nearly a shape of an elongated quadratic prism.

Moreover, each of the plurality of projections 31 included in uneven layers 30 and 30a to 30d has the elongated shape according to Embodiments 1 and 2 described above. However, the shape of projection 31 is not limited to this. As an example, each of the plurality of projections 31 included in uneven layers 30 and 30a to 30d may be arranged to be scattered in a matrix-like manner. More specifically, the plurality of projections 31 may be arranged in a dotted manner.

Furthermore, the plurality of projections 31 included in uneven layers and 30a to 30d have the same height according to Embodiments 1 and 2 described above. However, the heights of the plurality of projections 31 are not limited to this. For example, the plurality of projections 31 may have randomly different heights. This can suppress a state in which the light passing through the optical device becomes iridescent. To be more specific, since the plurality of projections 31 are randomly different in height, minute diffracted or scattering light rays on an uneven interface are averaged over wavelengths and thus coloring of the emitted light is suppressed. Moreover, spaces (pitches) between projections 31, instead of the heights, may be randomly different. This can also suppress the state in which the light passing through the optical device becomes iridescent.

Furthermore, the negative liquid crystal is used as the material of refractive-index adjustment layers 40 and 40a to 40d according to Embodiments 1 and 2 described above. However, a positive liquid crystal may be used.

Moreover, in Embodiments 1 and 2 described above, the material used for refractive-index adjustment layers 40 and 40a to 40d may contain, in addition to the liquid crystal material, a high molecule having, for example, a polymer structure. The polymer structure is, for example, a network structure. Liquid crystal molecules are disposed into the polymer structure (meshes of the network). With this, the refractive index becomes adjustable. Examples of the liquid crystal material containing high molecules include polymer dispersed liquid crystal (PDLC) and polymer network liquid crystal (PNLC).

Furthermore, although sunlight is described as an example of the light entering the optical device according to the embodiments and variations described above, the light entering the optical device is not limited to sunlight. For example, the light entering the optical device may be light that is emitted by a light-emitting device, such as an illuminating device.

Moreover, although the optical device is affixed to the window according to the embodiments and variations described above, this is not intended to be limiting. The optical device itself may be used as the window of building 4. In addition, an installation position of the optical device is not limited to a window of a building, and may be a car window, for example.

It should be noted that other embodiments implemented through various changes and modifications conceived by a person of ordinary skill in the art based on the above embodiments and variations or through a combination of the structural components and functions in the above embodiments and variations unless such combination departs from the scope of the present invention may be included in the scope in an aspect or aspects according to the present invention.

### REFERENCE MARKS IN THE DRAWINGS

1, 1A, 1B, 1C, 1D, 9 optical device
4a window
10, 110 first substrate
20, 120 first electrode
30, 130 uneven layer
40, 140 refractive-index adjustment layer
50, 50A, 50D, 150 second electrode
51 pattern electrode
52, 152 separation region
60, 160 second substrate
70 third electrode
90 supporting substrate
100 optical element

1. An optical device comprising:
a substrate which is light-transmissive;
a first electrode which is disposed above the substrate;
an uneven layer which is disposed above the first electrode;
a refractive-index adjustment layer which is disposed above the uneven layer; and
a second electrode which is disposed above the refractive-index adjustment layer,
wherein at least one of the first electrode and the second electrode includes a plurality of pattern electrodes which are aligned in a first direction,
the plurality of pattern electrodes include pattern electrodes which are adjacent to each other and separation regions are each formed between adjacent ones of the plurality of pattern electrodes, and
at least one of areas of the plurality of pattern electrodes and areas of the plurality of separation regions vary successively in the first direction.

2. The optical device according to claim 1,
wherein the areas of the plurality of pattern electrodes decrease gradually in the first direction.

3. The optical device according to claim 1,
wherein the areas of the plurality of separation regions increase gradually in the first direction.

4. The optical device according to claim 1,
wherein the plurality of pattern electrodes are electrically connected to each other.

5. The optical device according to claim 4,
wherein the plurality of pattern electrodes are connected in series.

6. The optical device according to claim 5,
wherein each of the plurality of pattern electrodes is formed in a shape of a strip which is elongated in a second direction that crosses the first direction, and
each of the plurality of pattern electrodes is connected to an adjacent one of the plurality of pattern electrodes via a longitudinal end portion of the pattern electrode, in a manner that the plurality of pattern electrodes form a serpentine shape.

7. The optical device according to claim 4,
wherein each of the plurality of pattern electrodes is formed in a shape of a strip which is elongated in a second direction that crosses the first direction, and
each of the plurality of pattern electrodes is connected to an adjacent one of the plurality of pattern electrodes via one of longitudinal end portions of the pattern electrode.

8. The optical device according to claim 4,
wherein the plurality of pattern electrodes are connected in parallel.

9. The optical device according to claim 8, further comprising:
a third electrode which opposes the substrate,
wherein each of the plurality of pattern electrodes is electrically connected to the third electrode.

10. The optical device according to claim 1,
wherein one of the first electrode and the second electrode includes the plurality of pattern electrodes, and
an other one of the first electrode and the second electrode is an electrode film which is a single film covering the plurality of pattern electrodes.

11. The optical device according to claim 10,
wherein the second electrode includes the plurality of pattern electrodes, and
the first electrode is the electrode film.

12. The optical device according to claim 1,
wherein each of the plurality of pattern electrodes is divided into a plurality of segmented electrodes in the first direction.

13. An optical device comprising:
a supporting substrate; and
a plurality of optical elements which are aligned above the supporting substrate in a first direction,
each of the plurality of optical elements including:
a substrate which is light-transmissive;
a first electrode which is disposed above the substrate;
an uneven layer which is disposed above the first electrode;
a refractive-index adjustment layer which is disposed above the uneven layer; and
a second electrode which is disposed above the refractive-index adjustment layer,
wherein the plurality of optical elements include optical elements which are adjacent to each other and separation regions are each formed between adjacent one of the plurality of optical elements, and
at least one of areas of the plurality of optical elements in a plan view and areas of the plurality of separation regions vary successively in the first direction.

14. A window provided with a light distribution function, the window comprising:
the optical device according to claim 1; and
a window to which the optical device is affixed.

15. The window provided with the light distribution function according to claim 14,
wherein the optical device includes one of a pattern electrode and a separation region, in a position corresponding to a lowermost portion of the window, the pattern electrode being included in the plurality of pattern electrodes and having a smallest area among the plurality of pattern electrodes, the separation region being included in the plurality of separation regions and having a largest area among the plurality of separation regions.
